(19) United States
(12) Patent Application Publication
(10) Pub. No.: US 2026/0257910 A1
(43) Pub. Date: Sep. 3, 2026

(54) METHOD FOR MANUFACTURING THREE-DIMENSIONAL NANOSTRUCTURES HAVING A LARGE ASPECT RATIO

(71) Applicant: HUMMINK, PARIS (FR)

(72) Inventors: Marc PASCUAL, PARIS (FR); Nathan BIGAN, WATTIGNIES (FR); Amin M'Barki, Maisons-Alfort (FR)

(21) Appl. No.: 18/993,283

(22) PCT Filed: Jul. 13, 2023
(86) PCT No.: PCT/FR2023/051087

§ 371 Date: Jan. 10, 2025

(30) Foreign Application Priority Data
Jul. 13, 2022 (FR) FR2207221

(51) Int. Cl. B82B 3/00; B22F 1/0545; B33Y 10/00; B33Y 70/10; B33Y 80/00; B82B 1/00

(52) U.S. Cl. CPC B82B 3/0019; B22F 1/0545; B82B 1/001; B33Y 10/00; B33Y 70/10; B33Y 80/00

(57) ABSTRACT

The invention relates to a method for manufacturing a three-dimensional nanostructure, the method comprising the following steps:
oscillating an injector (100) between a low position in contact with a substrate (20) and a high position out of contact with the substrate (20), the injector (100) comprising an ejection orifice (108) the diameter of which is greater than 0.1 μm;
depositing an ink on the substrate (20) by means of the injector during a contact of the ejection orifice (108) of the injector (100) with the substrate (20), the ink comprising, in % by volume relative to the total volume of the ink:
less than 15% nanoparticles chosen from metal nanoparticles, metal oxide nanoparticles, graphene oxide nanoparticles, or combinations thereof;
0.5% to 5% dispersant,
at least 80% of a solvent capable of dispersing the metal nanoparticles in order to form the ink to be injected and sufficiently volatile to allow solidification of the ink once it is deposited; and
withdrawing the injector (100) from the substrate (20) at a speed of less than or equal to 10 μm/s in a direction substantially perpendicular to the substrate while maintaining a flow of ink exiting from the injector.

The invention also relates to the nanostructures obtained by this method.

### FIELD OF THE INVENTION

The invention relates to the manufacture of three-dimensional nanostructures and, in particular, nanostructures having a large aspect ratio, greater than 1, such as nanostructured pillars for example. These pillars can, in particular, have the shape of columns having a diameter in the upward direction that is substantially constant, or of rounded conical pins having a diameter which decreases in the upward direction.

The three-dimensional nanostructures may be used in the fields of microelectronics, optoelectronics, energy conversion, manufacture of nano-devices or nano-sensors, in particular in order to be incorporated in screens, processors (and in particular quantum processors) or in-vitro diagnostic devices.

### PRIOR ART

Various techniques exist for producing three-dimensional nanostructures having an aspect ratio greater than 1.

The aspect ratio of a structure is understood here as the ratio of two dimensions of this structure. In particular, when the structure extends in a direction of extension and forms, for example, a pillar or a pin, the aspect ratio is the ratio between the length of the structure in the extension direction and a width of the structure in a direction transverse or perpendicular to this extension direction. The larger the ratio, the more the structure appears stretched in the extension direction and, in the case of a pillar, the lower its diameter with respect to its height.

A three-dimensional nanostructure having an aspect ratio greater than 10:1 may be manufactured by direct 3D printing with a silver Newtonian ink which has the property of drying quickly. See, on this topic, Lee et al. ACS Appl. Mater. Interfaces 2017, 9, 22, 18918-18924. However this technique produces structures having very rugged surfaces.

There are also techniques based on the polymerisation of photosensitive solutions. They require the use of mixtures of a metal colloidal suspension and photosensitive monomers, monomers which polymerise during manufacturing. The structure produced is, however, porous and has poor electrical conduction properties. These techniques can also be used to produce moulds for nanoimprint lithography (NIL). The manufacturing process is therefore more expensive because it requires one mould per size and per arrangement of nanostructures.

Techniques also exist that are based on the application of an electric field between a conductive substrate and a conductive suspension, such as electrodeposition techniques or redox electro-hydrodynamic techniques such as those described by Reiser et al. (Nature Communications, vol. 10, 1, 2019). They require the use of a conductive ink and support, in particular due to galvanisation constraints. The manufacturing speeds are slow because they are limited by the kinetics of the chemical reaction which takes place at the capillary tip or at the tip of the AFM used. In addition, in the case of electro-hydrodynamic techniques, these require a drop-by-drop (thus discontinuous) deposition, producing satellite droplets which generate undesirable surface irregularities.

Finally, there are techniques based on application by direct printing, in which the deposition of the metal ink is monitored by a camera.

There is therefore a need for a method for manufacturing three-dimensional nanostructures having an improved surface state, enabling a shorter or more simple manufacturing time by eliminating the need for a system to monitor the deposition by camera.

### DISCLOSURE OF THE INVENTION

An object of the invention is to propose a method for manufacturing three-dimensional nanostructures, and in particular nanostructures having an aspect ratio greater than 1, making it possible to produce nanostructures having surfaces that can be smoother or stratified, at a speed quicker than in the prior art, and this without requiring a conductive substrate as in some of the prior art.

This object is achieved in the context of the present invention by a manufacturing method according to the claim, in other words a method comprising the following steps:
oscillating an injector (100) between a low position in contact with a substrate (20) and a high position out of contact with the substrate (20), the injector (100) comprising an ejection orifice (108) the diameter of which is greater than 0.1 μm;
depositing an ink on the substrate (20) by means of the injector during a contact of the ejection orifice (108) of the injector (100) with the substrate (20), the ink comprising, in % by volume relative to the total volume of the ink:
less than 15% nanoparticles, chosen from metal nanoparticles, metal oxide nanoparticles, graphene oxide nanoparticles, quantum dots, or combinations thereof;
0.5% to 5% dispersant,
at least 80% of a solvent capable of dispersing the metal nanoparticles to form the ink to be injected and sufficiently volatile to allow solidification of the ink once it is deposited; and
withdrawing the injector (100) away from the substrate (20) at a speed of less than or equal to 10 μm/s in a direction substantially perpendicular to the substrate while maintaining a flow of ink exiting from the injector.

The expression “substantially perpendicular” means that the direction forms an angle of 90°±10° with the substrate that serves as its base.

The method step consisting of withdrawing the injector from the substrate in a direction non-parallel to the substrate while maintaining a flow of ink exiting from the injector, makes it possible to manufacture nanostructured pillars having an aspect ratio greater than 1, such as, for example, pillars of 1 μm diameter and 30 μm length. These pillars also advantageously have low surface roughness. Moreover, this method accelerates the manufacture of pillars by several seconds per pillar and may be implemented with any substrate, without galvanisation constraints.

Such a method is advantageously further characterized by the various following features, taken alone or in combination:
the ink comprises from 0.05% to 15% by volume, advantageously from 0.2% to 10% by volume, more advantageously from 4 to 8% by volume of nanoparticles, relative to the total volume of the ink;
the diameter of the ejection orifice (108) ranges from 0.1 μm to 50 μm, advantageously from 0.5 μm to 30 μm;
the volatile solvent comprises a solvent chosen from water, an alcohol, a glycol, a glycol ether, and mixtures thereof;
the ink comprises from 80% to 99.45% by volume of said solvent, relative to the total volume of the ink;
the volatile solvent further comprises a second solvent, said second solvent being glycerol, advantageously with a content such that the ink comprises from 0% to 25% by volume glycerol, relative to the total volume of the ink;
the metal of the metal nanoparticles is chosen from silver, copper, gold, platinum, nickel, aluminium, cobalt, combinations thereof or alloys thereof;
the metal oxide of the metal oxide nanoparticles is chosen from ZnO, TiO₂ or V₂O₅;
the ink further comprises a dispersant, advantageously chosen from polyvinylpyrrolidone (PVP), gum Arabic, polyvinyl alcohol (PVA), polyacrylic acid (PAA) polyallylamine (PAAm), polysodium styrene sulfonate (PSS), 3-(aminopropyl)trimethylsylane (APS), a fatty acid, cetyltrimethylammonium bromide (CTAB), tetraoctylammonium bromide (TOAB), sodium citrate, lauryl amine, dodecanethiol, mercapto-polyethylene glycol, mercapto-polypropylene glycol, or combinations thereof.
the injector withdraws at a speed ranging from 1 μm/s to 10 μm/s during the step of the injector withdrawing away from the substrate;
the method comprises a step of breakage between the three-dimensional nanostructure formed and the ink to be deposited, advantageously by withdrawing the injector (100) from the substrate (20) at a speed greater than 10 μm/s;
the method comprises carrying out, at least once, a cycle of the following steps so as to form at least one second three-dimensional nanostructure:
moving the injector in relation to the substrate (20) in a direction parallel (x,y) to the substrate, and
carrying out the method steps previously described.
the method comprises a step of curing the substrate containing the nanostructure formed.

The invention also relates to a product comprising a three-dimensional nanostructure obtained by means of a method such as has just been described.

Such a product is advantageously further characterized in that the nanostructure has a length at least ten times greater than the widths of the nanostructure.

In another alternative, such a product is advantageously further characterized in that the nanostructure has a diameter which decreases in the direction of the height.

### DESCRIPTION OF THE FIGURES

Other features and advantages of the invention will emerge from the following description, which is given purely by way of illustration and is not to be construed as limiting, and which should be read with reference to the attached drawings, in which:

FIG. 1 is a schematic representation of the formation of pillars;

FIG. 2 is a schematic representation of a system for manufacturing a three-dimensional nanostructure according to one of the embodiments of the invention;

FIG. 3 presents pictures of shapes of pillars that can be obtained by the method according to the invention.

FIG. 4 presents pictures of shapes of pillars obtained in test 3 (4A), in test 4 (4B) or of the flattened dome according to test 8 (4C).

FIG. 5 presents a picture of the result after implementing comparative example 1.

FIG. 6 presents pictures of shapes of pillars obtained in example 6 (6A: D=5 μm, 6B: D=10 μm);

FIG. 7 presents a picture of the pillar obtained in test 33.

FIG. 8 presents two pictures of the result after implementing comparative example 2.

FIG. 9 presents a picture of the pillar obtained in test 35.

FIG. 10A is a graphical representation reporting the maximum withdraw speed of the pipette, Ve in μm/s, as a function of the diameter of the pipette used for a concentration by volume of metal particles in the ink of 5.8% and

FIG. 10B is a graphical representation reporting the maximum withdraw speed of the pipette, Ve in μm/s, the pipette having a diameter of 5±1 μm, as a function of the concentration by volume of metal particles in the ink.

FIG. 11 presents a picture of the pillar obtained in test 37.

FIG. 12 presents the picture of the pillar obtained in example 9.

### DETAILED DESCRIPTION OF THE INVENTION

A system enabling controlled depositing of an ink on any substrate has already been described in application WO2020/128310. The system described in this application enables the depositing of an ink having a form defined by a length greater than or equal to 1 μm. The system comprises a mechanical resonator attached to an injector.

It has now been discovered that under certain conditions, it was possible to deposit an ink and to stretch it in a direction of extension in order to form a nanostructure such as a column or a pin.

To do this, the method as described in application WO 2020/128310 comprises a step of withdrawing the injector from the substrate in a direction that is not parallel to, in particular is substantially perpendicular to, the substrate, at a speed less than or equal to 10 μm/s and the ink to be deposited comprises metal nanoparticles and/or metal oxide nanoparticles and/or graphene oxide particles and a sufficiently volatile solvent.

In the present invention, the term “stretching” means that the depositing is continuous, in contrast to drop-by-drop depositing, for example.

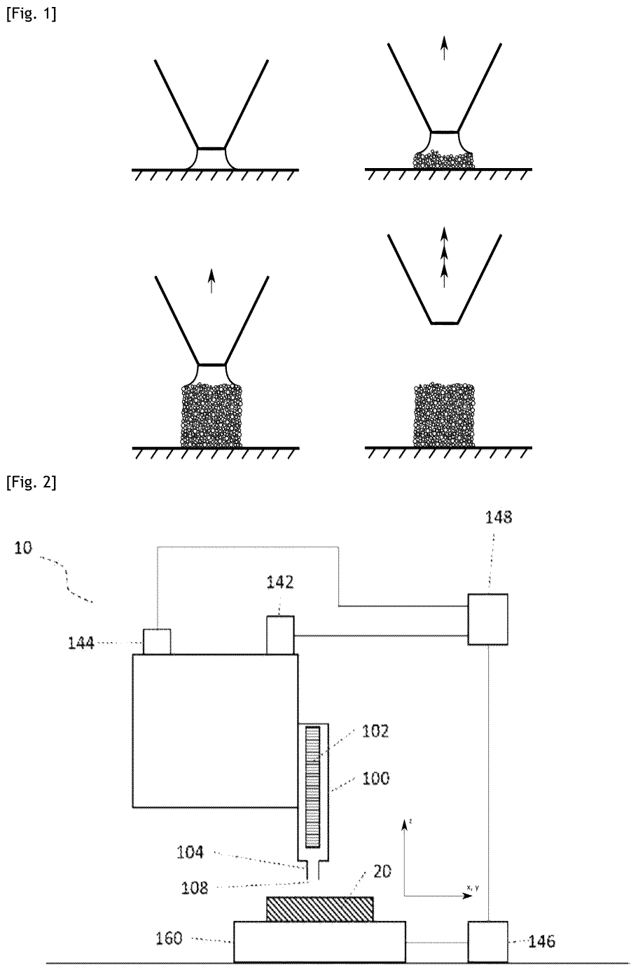

The three-dimensional nanostructure is formed by evaporation at the outlet of the ejection orifice, of the solvent present in the ink. As shown in FIG. 1:
the substrate and the ejection orifice of the injector are brought towards one another. When contact is made, a liquid meniscus of the ink contained in the injector appears between the outlet of the ejection orifice and the substrate (1A);
the ejection orifice of the injector and the substrate are withdrawn from one another at a speed less than or equal to 10 μm/s, the solvent evaporates inducing a concentration and/or a local accumulation of nanoparticles, the inventors believe, at the liquid-gas interface of the meniscus, which causes the formation of a solid phase composed of a dense agglomerate of nanoparticles (1B and 1C);
the ejection orifice of the injector and the substrate are withdrawn from one another at a speed greater than 10 μm/s in order to detach the ejection orifice of the injector from the three-dimensional nanostructure formed (1D).

The ink used comprises metal nanoparticles or metal oxide nanoparticles or graphene nanoparticles or optionally quantum dots, also referred to as nanoparticles hereinafter, and a volatile solvent.

Advantageously, the ink comprises 0.05% to 15% by volume, advantageously 0.2% to 10% by volume, more advantageously 4 to 8%, by volume nanoparticles, relative to the total volume of the ink.

The nanoparticles advantageously have an average particle size, D50, ranging from 1 nm to 300 nm, advantageously 30 nm to 200 nm. The particle size may be determined by high-resolution scanning electron microscopy (HRSEM) or by light transmission analysis (such as with the Lumisizer®) instrument.

The nanoparticles are advantageously conductive or semiconductive nanoparticles. They are, advantageously, metal nanoparticles the metal of which is chosen from silver, copper, gold, platinum, nickel, aluminium, cobalt, zinc, indium, palladium, combinations thereof or alloys thereof. In particular, the nanoparticles are metal nanoparticles, the metal of which is chosen from the silver, copper, gold, platinum, nickel, aluminium, cobalt, combinations thereof or alloys thereof.

The metal oxide of the metal oxide nanoparticles is advantageously chosen from ZnO, TiO₂, ITO (indium tin oxide), or V₂O₅.

The quantum dots can advantageously be as described in documents EP2820108, US2014353579 or WO2023274486 for example.

The ink advantageously further comprises a dispersant; in other words an additive promoting the dispersion of the metal particles in the ink and enabling, in particular, the stability of the ink.

Advantageously, the ink comprises 0.5% to 5% by volume, advantageously 1% to 2% by volume, dispersant, relative to the total volume of the ink.

The dispersant is advantageously chosen from polyvinylpyrrolidone (PVP), gum Arabic, polyvinyl alcohol (PVA), polyacrylic acid (PAA), polyallylamine (PAAm), polysodium styrene sulfonate (PSS), 3-(aminopropyl)trimethylsylane (APS), a fatty acid, cetyltrimethylammonium bromide (CTAB), tetraoctylammonium bromide (TOAB), sodium citrate, lauryl amine, dodecanethiol, mercapto-polyethylene glycol, mercapto-polypropylene glycol, or combinations thereof.

The dispersant may be a polymer with a number average molecular weight, Mw, ranging from 5000 g/mol to 2,000,000 g/mol. The dispersant is preferably PVP. The molecular weight, Mw, of the PVP is advantageously at least 8000 g/mol, more advantageously from 10,000 g/mol to 1,600,000 g/mol, still more advantageously 10,000 g/mol to 200,000 g/mol. When the nanoparticles are silver or copper nanoparticles, the dispersant is advantageously chosen from polyvinylpyrrolidone (PVP), gum Arabic, polyvinyl alcohol (PVA), polyacrylic acid (PAA), polyallylamine (PAAm), polysodium sulfonate (PSS), 3-(aminopropyl)trimethylsylane (APS), a fatty acid, cetyltrimethylammonium bromide (CTAB), tetraoctylammonium bromide (TOAB), sodium citrate, lauryl amine, or combinations thereof.

When the nanoparticles are gold nanoparticles, the dispersant is advantageously chosen from mercapto-polyethylene glycol, mercapto-polypropylene glycol, dodecanethiol, sodium citrate, polyvinylpyrrolidone (PVP) or combinations thereof. The dispersant is preferably mercapto-polyethylene glycol. The molecular weight, Mw, of mercapto-polyethylene glycol is advantageously at least 100 g/mol, more advantageously from 400 g/mol to 2000 g/mol.

The solvent is firstly a solvent enabling the dispersion of the nanoparticles, without notable agglomeration in the ink. The ink being most often a commercial ink, the solvents used are already solvents enabling good dispersion of the nanoparticles. In certain cases, a miscible solvent is added to these commercial inks enabling their volatility to be modified.

When the metal particles are silver or copper, examples of solvents enabling their good dispersion, and suitable for the method according to the invention, are in particular alcohols, glycols, glycol ethers, and mixtures thereof. Of course, the mixtures that may be chosen are those between miscible solvents.

When the metal particles are gold, examples of solvents enabling their good dispersion, and suitable for the method according to the invention, are in particular water, alcohols, toluene and mixtures thereof. Of course, the mixtures that may be chosen are those between miscible solvents.

In addition to this ability to disperse the nanoparticles, the solvent must be sufficiently volatile in order to enable the formation of a solid phase. Indeed, it is desired that once contact is made between the ejection orifice of the injector and the substrate, the solvent evaporates sufficiently quickly to enable a local concentration/accumulation of nanoparticles while limiting, or even without, spreading of the ink on the substrate.

On the other hand, in order to avoid any phenomenon of plugging of the outlet of the ejection orifice of the injector, the solvent must not evaporate too quickly.

The solvent or solvent mixture is therefore advantageously suitable for enabling the formation of a solid phase, while avoiding, on the one hand, the formation of a plug or the breakage of the deposit and, on the other hand, avoiding or limiting the spreading of the ink on the substrate.

The speed of evaporation of the solvent depends, of course, on the volatility of the solvent, which itself depends on the operating conditions (temperature, pressure, ambient humidity, speed withdraw speed of the substrate and ejection orifice and diameter of the ejection orifice) but also on the volume fraction of nanoparticles in the ink.

Hence, depending on the operating conditions, the ink will comprise a solvent or several solvents, the solvents in this case being miscible with one another.

In particular, a second solvent of lower volatility may be added to ensure a sufficient handling time between the formation of two structures.

Without wishing to limit themselves, the inventors think that the characteristic time of evaporation of the solvent t corresponds to the following formula

$${τ}^{2} ∼ \frac{{D}^{2}}{{P}_{v a p}} \cdot \frac{{ρ}_{s o l}}{{x}_{v}^{N P s}} \qquad [ Math . 2 ]$$

with D the diameter of the ejection orifice (108),
Pᵥₐₚ the saturated vapour pressure of the solvent or of the mixture of solvents at the printing temperature, in general ambient temperature,
ρₛₒₗ the density of the solvent or of the mixture of solvents at the printing temperature, in general ambient temperature,
xᵥ^{NPs} the volume fraction of nanoparticles.

Alternatively, and without wishing to be bound by the theory, on the basis of the work of Davis and Ray (J. Chem. Phys. 67, 414 (1977)), the inventors postulate that the speed of evaporation of the solvent in a drop of ink follows the following equation:

$$( 1 - {x}_{N P} ) \frac{da}{dt} = - \frac{{D}_{12} {p}_{v a p} {M}_{1}}{a {ρ}_{l i q} R T} \qquad [ Math . 3 ]$$

wherein
x_{NP} represents the volume fraction of nanoparticles in the ink, a represents the radius of a drop (in m),
D₁₂ represents the coefficient of diffusion of the solvent (1) in the gas (2) (in m²·s⁻¹),
pᵥₐₚ represents the saturated vapour pressure of the solvent at temperature T (in Pa),
M₁ represents the molar mass of the solvent (in kg·mol⁻¹)
ρ_{liq} represents the density of the solvent of the ink at temperature T (in kg·m⁻³)
R represents the universal ideal gas constant (in J·K⁻¹·mol⁻¹)
T represents the temperature (in Kelvin).

The gas (2) is in general air.

After integration, it is deduced that the characteristic time for evaporation of the solvent t is proportional to the following formula:

$$τ ∼ \frac{{r}^{2} {ρ}_{l i q} R T}{2 {D}_{12} {p}_{ν a p} {M}_{1}} ( 1 - {x}_{N P} ) \qquad [ Math . 4 ]$$

wherein
x_{NP} represents the volume fraction of nanoparticles in the ink,
r represents the radius of the ejection orifice (108) (in m),
D₁₂ represents the coefficient of diffusion of the solvent (1) in the gas (2) (in m²·s⁻¹),
pᵥₐₚ represents the saturated vapour pressure of the solvent at temperature T (in Pa),
M₁ represents the molar mass of the solvent (in kg·mol⁻¹)
ρ_{liq} represents the density of the solvent of the ink at temperature T (in kg·m⁻³)
R represents the universal ideal gas constant (in J·K⁻¹·mol⁻¹)
T represents the temperature (in Kelvin).

The gas (2) is in general air.

In the case where the solvent is a mixture, the average values are of course used, weighted as a function of the volume fraction of each solvent for the values of pᵥₐₚ, ρ_{liq}, and D₁₂. These relations have been verified by experimental measurements, which appear to indicate that the coefficient of proportionality is substantially equal to 1.

Advantageously, the conditions for the diameter of the ejection orifice, saturated vapour pressure of the solvent or mixture of solvents, density of the solvent or mixture of solvents and volume fraction of nanoparticles are such that the characteristic time for evaporation of the solvent, t, varies from 0.1 s to 1000 s, in particular from 0.1 to 300 s, advantageously from 1 s to 30 s, more advantageously from 2 s to 10 s. Preferably, the conditions for radius of the ejection orifice, saturated vapour pressure of the solvent or mixture of solvents, the density of the solvent or mixture of solvents and the volume fraction of nanoparticles are such that the characteristic time for evaporation of the solvent, τ, advantageously as determined according to equation Math4, varies from 10 s to 300 s, in particular from 30 s to 300 s.

It is observed that, according to the two equations Math 2 and Math 4, when the volume fraction of nanoparticles in the ink increases, the volatility of the solvent must be reduced.

It is also observed that it is necessary to reduce the withdraw speed when the solvent has a lower evaporation rate.

Advantageously, the volume fraction of nanoparticles in the ink, the radius of the ejection orifice (108), and the solvent are chosen (the temperature and gas generally being fixed at 300 Kelvin and as air respectively) in such a way that the characteristic time for evaporation of the solvent, τ, advantageously as determined according to equation Math4, varies from 10 s to 300 s, in particular from 30 s to 300 s.

Advantageously, the volatile solvent comprises a solvent chosen from water, an alcohol, a glycol, a glycol ether and mixtures thereof. In the case of solvent mixtures, of course, the solvents must be miscible and the mixture continuous in order to ensure its role in dispersing the nanoparticles.

Examples of alcohol include, in particular, methanol, ethanol, isopropanol, 1-propanol, benzyl alcohol and terpineol.

Examples of glycol include, in particular, ethylene glycol, propylene glycol, butylene glycol, pentylene glycol, hexylene glycol, diethylene glycol and triethylene glycol.

Examples of glycol ether include, in particular:
ethylene glycol ether, propylene glycol ether;
propylene glycol monomethyl ether, propylene glycol monoethyl ether, propylene glycol monopropyl ether, propylene glycol monobutyl ether, propylene glycol mono-t-butyl ether, propylene glycol monophenyl ether, dipropylene glycol monomethyl ether, dipropylene glycol monoethyl ether, dipropylene glycol monopropyl ether, dipropylene glycol monobutyl ether, propylene glycol mono-t-butyl ether, tripropylene glycol monoethyl ether, tripropylene glycol monopropyl ether and tripropylene glycol monobutyl ether;
ethylene glycol monomethyl ether, ethylene glycol monoethyl ether, ethylene glycol monopropyl ether, ethylene glycol monobutyl ether, ethylene glycol monophenyl ether, diethylene glycol monomethyl ether, diethylene glycol monoethyl ether, diethylene glycol monopropyl ether, diethylene glycol monobutyl ether, diethylene glycol mono-t-butyl ether, triethylene glycol monopropyl ether and triethylene glycol monobutyl ether.

In particular, the solvent is chosen from water, ethanol, ethylene glycol (EG), diethylene glycol methyl ether (DGME), diethylene glycol ethyl ether (DGEE), diethylene glycol butyl ether (DGBE), triethylene glycol methyl ether (TGME), propylene glycol ethyl ether (PGME), the tripropylene glycol methyl ether (TPME), and mixtures thereof.

Advantageously, the ink comprises 80% to 99.45% by volume of said solvent, relative to the total volume of the ink. This content corresponds to the content of first solvent and second solvent, when it is present, as defined below.

This solvent, also called first solvent, may be used alone. Alternatively, it may be mixed with a less volatile solvent, called second solvent.

As indicated, the ink can comprise a second solvent of much lower volatility relative to the first solvent. This second solvent is advantageously hygroscopic. Thus, advantageously, the volatile solvent comprises a second solvent chosen from glycerol, advantageously with a content such that the ink comprises 0% to 25% by volume glycerol, relative to the total volume of the ink.

The aim of the presence of the second solvent is to prevent too rapid drying and plugging of the ejection orifice. According to the degree of humidity of the air and the volume fraction of the second solvent, the ejection orifice may be left unused in the air for 1 minute to 30 minutes, before resuming the formation of nanostructures.

Thus, it is for example possible to create nanostructures one after the other with a time interval ranging from 30 s to 30 minutes between each, without the ejection orifice plugging between two nanostructures.

Advantageously, the ink comprises, more advantageously consists of, four families of ingredients:
the nanoparticles as previously described, in a volume concentration ranging from 0.05 vol % to 15 vol %, preferably between 4 vol % and 8 vol %;
the dispersant as previously described, in a volume concentration ranging from 0.5 vol % to 5 vol %, preferably from 1 vol % to 2 vol %;
a first solvent chosen from water, ethanol, ethylene glycol (EG), diethylene glycol methyl ether (DGME), diethylene glycol ethyl ether (DGEE), diethylene glycol butyl ether (DGBE), triethylene glycol methyl ether (TGME), propylene glycol ethyl ether (PGME), tripropylene glycol methyl ether (TPME), and mixtures thereof;
0 to 25 vol % glycerol.

The percentages are expressed by volume relative to the total volume of the ink. When the ink consists of these four families of ingredients, it comprises 55% to 99.45 vol % of said first solvent.

### System for Manufacturing a Three-Dimensional Nanostructure

FIG. 2 shows an embodiment of a system 10 for manufacturing a three-dimensional nanostructure on a substrate 20.

In this case, the system 10 comprises all the features of the system for controlled depositing of an ink on a substrate such as was presented in application WO2012/078590. That document is incorporated by reference. It is possible to refer to that application for more details on the known aspects of the technique implemented.

The system 10 for manufacturing a three-dimensional nanostructure on a substrate 20 comprises an injector 100 of nanometric size.

The injector 100 comprises a tank 102 for storing the ink and a non-deformable protuberance 104. The injector 100 comprises an ejection orifice 108 for extracting the ink from the tank 102.

The diameter of the ejection orifice 108 ranges from 0.1 to 50 microns, advantageously from 0.5 μm to 30 μm.

The system 10 also comprises a conveyor or movement means 160 suitable for moving the substrate 20 relative to the injector 100. The movement may be carried out in a direction z that is not parallel to the substrate, as well as in directions x and y parallel to the substrate. The movement means 160 may be a piezoscanner on which the substrate 20 is deposited. It may be, in particular, a piezoscanner with three axes having a sub-nanometric movement resolution.

The system 10 further comprises a mechanical resonator attached to the injector 100. The mechanical resonator may be in the form of a diapason, the body of which is screwed to its base on a block which moves along the three spatial axes via a system of micrometric screws.

The system 10 further comprises a controller or control means 148 of the mechanical resonator. The controller 148 comprises a first PID controller 1 connected to an exciter or exciting means 142 suitable for exciting the mechanical resonator.

The system 10 comprises the exciting means 142, which may be a piezoelectric exciter. This exciter is bonded on the mechanical resonator.

The control means 148 is further connected to a detector or detecting means 144 suitable for detecting the oscillation of the mechanical resonator so as to read the response of the mechanical resonator to the excitation of the exciting means 142. The system 10 comprises the detector 144 which may be an accelerometer bonded on the mechanical resonator.

The detector 144 is capable of detecting variations of oscillation, and in particular variations in the frequency of oscillation of the injector of less than 1 Hz, advantageously between 10 mHz and 200 mHz.

The control means 148 is further connected to a regulator or regulating means 146 suitable for adjusting the contact between the protuberance 104 and the substrate 20 by controlling the oscillation of the mechanical resonator.

The system 10 comprises the regulator 146 which is a second PID controller 2 and enables the adjustment of the contact using the conveyor or movement means 160 to which it is connected.

With regard to the excitation of the resonator, it should be noted that the piezoelectric exciter may be powered by an electrical signal, the frequency of which corresponds to its mechanical excitation frequency. The frequency of this electrical signal is adjusted by the first PID controller 1 in order to control the oscillation of the diapason such that the response of the diapason detected by the accelerometer is in phase with the signal of the piezoelectric exciter so that the diapason oscillates according to the oscillation of the piezoelectric exciter. The setpoint of this feedback loop is therefore that the phase shift between the oscillation of the piezoelectric exciter and that of the diapason is zero. The diapason is therefore in phase with the piezoelectric exciter. The diapason is thus excited at its resonance frequency, which depends on its mechanical properties, but also on the interactions with its environment.

The control means 148 is suitable for depositing the previously described ink on the substrate 20 by means of the injector during a contact of the injector 100 with the substrate 20.

The control means 148 is connected to the conveyor 160 and is suitable for withdrawing the injector from the substrate 20 in the z direction which is not parallel to the substrate, while maintaining an ink flow exiting from the injector. The z direction may be the direction perpendicular to the plane of the substrate 20.

### Method for Manufacturing a Three-Dimensional Nanostructure

A manufacturing system as has just been presented can implement a method according to the invention for manufacturing a three-dimensional nanostructure.

An embodiment of the implementation of this method is presented below.

A first step of the method consists in oscillating the injector 100 between a low position in contact with a substrate 20, and a high position out of contact with the substrate 20. Typically, the injector oscillates at an amplitude ranging from 0.5 to 100 nm, advantageously from 1 to 20 nm, during this step.

For this purpose, the control means 148 can control the exciting means 142 in order to excite the mechanical resonator which will itself oscillate the injector 100. The protuberance 104 therefore oscillates between a low position, in which the protuberance 104 is in contact with the substrate 20 and a high position in which the protuberance 104 and the substrate 20 are not in contact.

The resonance of the system constituted by the diapason, the piezoelectric exciter and the accelerometer may be measured in such a way as to determine the resonance frequency of the diapason and its quality factor.

It is also possible to predefine a setpoint oscillating phase shift of the second PID controller 2, this phase shift corresponding to a phase shift induced by a predefined contact between the protuberance and the substrate 20. For example, this phase shift may be less than 1 Hz, advantageously ranging from 10 mHz to 200 mHz (milliHerz).

The substrate 20 is approached by the protuberance 104 using the conveyor 160 in such a way that the protuberance 104 oscillates between a low position, in which it is in contact with the substrate 20, and a high position, in which it is not in contact with the substrate 20. In this particular configuration of the protuberance 104 and the substrate 20, the forces applied to the assembly constituted by the diapason and the injector 100 are modified. This modifies the resonance frequency and therefore the excitation frequency of the piezoelectric exciter, which is held at the resonance frequency of the diapason.

It is possible to choose to define this configuration by a particular modification of the resonance frequency of the assembly constituted by the diapason and the injector 100, for example a modification less than 1 Hz, advantageously ranging from 10 mHz to 200 mHz. This modification is the induced phase shift mentioned above.

The system 10, through the detector 144, is suitable for identifying that particular configuration between the injector and the substrate which involves a variation of oscillations less than 1 Hz, advantageously ranging from 10 mHz to 200 mHz.

Using the second PID controller 2 and as a function of the variations of oscillations, it is possible to adjust the configuration so as to form an ink meniscus between the protuberance 104 and the substrate 20. The regulator or second PID controller 2 controls the fine approach between the substrate 20 and the injector 100 through a feedback loop, until the modification of the resonance frequency is less than 1 Hz, advantageously ranging from 10 mHz to 200 mHz.

A second step of the method consists in depositing the previously described ink on the substrate 20 by means of the injector during a contact of the injector 100 with the substrate 20.

When the contact is made, a meniscus of the liquid contained in the pipette (the ink previously described) appears between the ejection orifice 108 and the substrate 20 (see FIG. 1).

The contact is maintained by applying a constraint on the frequency shift of the resonance, said shift resulting from the interaction between the ejection orifice 108 and the substrate 20. The values of “frequency shift” used are advantageously from 40 mHz to 500 mHz. As previously indicated, the amplitude of oscillation of the diapason, and therefore of the protuberance 104, is fixed between 0.5 nm and 100 nm.

The ink thus deposited on the substrate forms the base of the manufactured three-dimensional nanostructure.

The method may comprise, before the third step which follows, a step during which the contact is maintained without withdrawing from the injector 100. This step, corresponding to an initiation time, makes it possible to concentrate the meniscus formed by nanoparticles. Thus, the more diluted the ink is, the greater the advantage in observing an initiation time. This initiation time advantageously varies from 1 s to 180 s.

A third step of the method consists in withdrawing the injector 100 from the substrate 20 in a direction that is not parallel, advantageously substantially perpendicular, to the substrate, while maintaining a flow of ink exiting from the injector.

The ink exiting from the injector during this step is deposited on the previously deposited ink so as to gradually form the three-dimensional nanostructure. The nanostructure produced thus comprises a portion which extends in the direction that is non-parallel, advantageously substantially perpendicular, to the substrate.

As previously indicated, the withdraw speed of the injector is adjusted so that the exiting ink solidifies rather quickly in order to act as a base for depositing the ink subsequently exiting.

For example, the system may be adjusted so that the injector withdraws at a predetermined speed less than or equal to 10 μm/s, advantageously ranging from 1 μm/s to 10 μm/s during this step.

Advantageously, once the contact is established, the substrate 20 is withdrawn from the protuberance 104 according to one of the two following modes:
1) the feedback control loop of movement means 160 via the regulator 146 (PID controller 2) is held active:

The appearance of the solid phase induces a local unevenness on the substrate, which leads to a frequency shift, detected by the phase-locked loop. The movement means 160 respond to this increase in the frequency shift by sufficiently withdrawing the substrate 20 in order to find the setpoint value of the frequency shift fixed at a value ranging from 40 mHz to 500 mHz. Thus, the creation of the pillar is initiated. This routine continues autonomously as long as the operator leaves the feedback control loop active and the pillar is continuously drawn from the tip of the ejection orifice 108. The deactivation of the feedback control loop of the movement means 160 suspends the generation of the pillar.

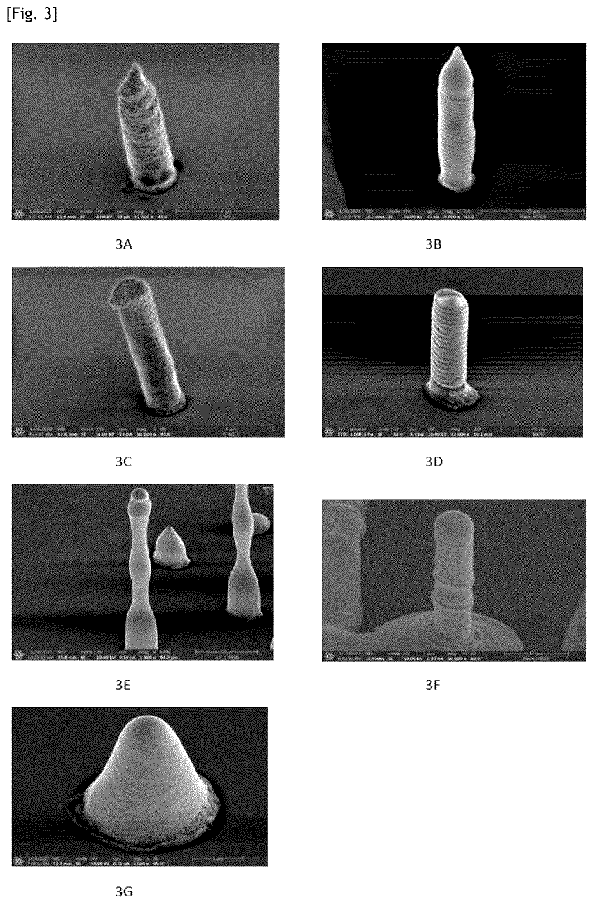

The pillars obtained according to this variant advantageously have a smooth appearance (FIGS. 3A, 3C). If the setpoint value is varied, the pillar may be given an undulating shape (FIG. 3E).
2) the feedback control loop of the movement means 160 is deactivated via the regulator 146 (PID controller 2):
just after the formation of the meniscus, the operator waits 1 s to 60 s in contact in order to initiate the formation of the pillar before manually withdrawing the substrate 20 from the protuberance 104 using the control software. The distance increments have a value of 0.01 μm to 10 μm, giving withdraw speeds ranging from 0.01 μm/s to 10 μm/s. An initiation time, advantageously of 0.1 s to 60 s, may be provided between each distance increment. The pillars obtained according to this variant, advantageously have a stratified appearance (FIGS. 3B, 3D). If the withdraw speed is varied, an undulating shape may be given to the pillar.

In any case, in order to detach the protuberance 104 from the pillar, in a fourth step, also called a breakage step, the substrate is withdrawn at a speed of at least 10 μm/s. It is known that the more rapid the withdrawing (>500 μm/s), the flatter will be the top of the pillar (FIGS. 3C, 3D). By contrast, too slow a withdrawing (<20 μm/s) gives the top of the pillar a conical shape, and the slower the withdrawing, the more elongate will be the cone (FIGS. 3A, 3B).

The method allows a manufacturing time of a pillar of approximately several seconds.

This method makes it possible to do without the use of a camera for monitoring and controlling the deposition. This method makes it possible to overcome a pressure force on the ink to be deposited.

It is thus possible to manufacture nanostructured pillars having an aspect ratio greater than 1, advantageously ranging from 10:1 to 50:1, such as pillars of 1 μm diameter and 30 μm in length.

Such pillars are obtained, in particular, using injectors for which the ejection orifice 108 has a diameter ranging from 0.1 μm to 50 μm, advantageously from 0.5 μm to 30 μm, more advantageously from 1 μm to 15 μm.

The shape of the pillars will depend on the operating conditions. As illustrated by example 1 and in FIG. 3, pillars may be formed having the following characteristic shapes:
smooth column of substantially constant diameter, terminating in a conical shaped top (FIG. 3A);
stratified column of substantially constant diameter, terminating in a conical shaped top (FIG. 3B);
smooth column of substantially constant diameter, terminating in a flat top (FIG. 3C);
stratified column of substantially constant diameter, terminating in a flat top (FIG. 3D);
smooth column with a varying diameter giving an undulating shape (FIG. 3E);
column having alternating smooth zones and stratified zones (FIG. 3F);
pillar in the form of a rounded conical pin, having a diameter which reduces in the direction of the height (FIG. 3G).

The method advantageously further comprises executing a relative movement of the injector relative to the substrate (20) in a direction parallel (x,y) to the substrate, in order to deposit the ink to form at least one line, according to the method described in WO 2020/128310. The method may be adapted for successively manufacturing a plurality of nanostructures. For this purpose, the method can further comprise executing, at least once, a cycle of the following steps so as to form at least one second three-dimensional nanostructure:
moving the injector in relation to the substrate 20 in a direction parallel (x,y) to the substrate, and
carrying out the steps of the method as previously presented.

The relative movement is ensured by the movement means 160. During the relative movement of the injector relative to the substrate (20) in a direction parallel (x,y) to the substrate, it is possible to deposit the ink to form at least one line, according to the method described in WO 2020/128310.

On each execution of the cycle of steps, a new nanostructure is manufactured.

Once the pillar or pillars are formed, the method advantageously comprises a curing step. The conditions of this step could be adjusted as a function of the nature of the metal or the oxide of the nanoparticles. For example, the pillars made of gold or silver are heated to a temperature ranging from 130° C. to 200° C. over a duration that can vary from 10 minutes to 2 hours. The pillars made of copper, the conditions of temperature and duration may be the same, it is just necessary to operate under a non-oxidising atmosphere, for example under argon, nitrogen or hydrogen. A photonic curing can also be carried out, which may be implemented under ambient atmosphere, even for copper pillars.

Advantageously, all the steps of the method are carried out at ambient temperature (18-22° C.) and at atmospheric pressure.

Finally, the invention relates to a product comprising a substrate on which a three-dimensional nanostructure is deposited, obtained by means of a method such as that just described.

According to an alternative, such a nanostructure is a column as previously described. Such a column advantageously has an aspect ratio greater than 10:1, more advantageously greater than 15:1, still more advantageously ranging up to 50:1, such that the column extends in a direction of extension on a length of extension at least ten times greater than the widths of the nanostructure in the directions perpendicular to the extension direction.

The direction of extension corresponds to the z direction which is non-parallel to, advantageously substantially perpendicular to, the substrate, in which the injector is withdrawn from the substrate during the method.

The base diameter of the column, corresponding to its largest width, is advantageously less than 10 μm, more advantageously less than 5 μm, still more advantageously less than 2 μm, for example 1 μm.

According to another alternative, such a nanostructure is a pin as previously described. The controllable parameters are the diameters of the base and of the apex of the pin, as well as the angle of the slope formed between its vertical wall and the axis perpendicular to the substrate. The diameter of the base advantageously varies from 0.5 μm to 50 μm, more advantageously from 1 to 30 μm. The diameter of the apex advantageously varies from 0.2 μm to 30 μm, more advantageously from 0.5 μm to 10 μm. The angle of the slope formed between its vertical wall and the axis perpendicular to the substrate advantageously varies from 0.1° to 70°, more advantageously from 10° to 45°.

Such a shape is of interest for producing solder bumps in the steps for packaging electronic chips. The conical pin is mechanically more stable than a column when a shear stress is applied to it. This typically occurs during a wafer bonding step when the pin deposited on the silicon wafer is compressed vertically by pressure of a silicon wafer 2. The small movements in x-y of said silicon wafers during the compression can misalign the column and compromise the proper bonding of the two silicon wafers. Because of its morphology, the conical pin is less subject to this phenomenon.

Advantageously, in any one of the variants, the substrate is non-conductive.

The following examples illustrate the invention.

### Characteristic Time for the Evaporation of Several Solvents

By using formula Math4 with the following parameters
x_{NP} is set at 0.06.
2a (diameter of the pipette)=1.5*10⁻⁵ m
R=8.3 J·K⁻¹·mol⁻¹
T=300 K
D₁₂ represents the coefficient of diffusion of the solvent (1) in air (gas (2)). It has been calculated using the Chapman-Enskog equation:

$${D}_{12} = \frac{3}{8} {( \frac{N}{2 π} ( \frac{1}{{M}_{s o l}} + \frac{1}{{M}_{a i r}} ) )}^{1 / 2} \frac{k {τ}^{3 / 2}}{p {σ}^{2} Ω}$$

in which
N represents Avogadro's number (6.02214076×10²³ mol⁻¹)
k represents the Boltzmann constant (1.380649×10⁻²³ J·K⁻¹)
T represents temperature, in Kelvin (300 K)
Mₛₒₗ represents the molar mass of the solvent, in kg·mol⁻¹
Mₐᵢᵣ represents the molar mass of air in kg·mol⁻¹ (0.029 kg·mol⁻¹)
p represents the pressure in Pa (1.01*10⁵ Pa)
σ represents the diameter corresponding to the effective cross-section of a solvent molecule, in m
Ω represents the collision integral reduced by its value for the collision of hard spheres, approximated to 1
pᵥₐₚ represents the saturated vapour pressure of the solvent at temperature 300 K.
ρ_{liq} represents the density of the solvent of the ink at temperature 300 K.

| | | DGEE (2-(2- | | | TEG |
|---|---|---|---|---|---|
| | | ethoxyethoxy) | Ethylene | | (triethylene |
| | Ethanol | ethanol) | Glycol (EG) | Glycerol | glycol) |
| Mₛₒₗ (kg · mol⁻¹) | 0.046 | 0.134 | 0.062 | 0.15 | 0.92 |
| σ (m) | 4.70*10⁻¹⁰ | 1.20*10⁻⁰⁹ | 6.50*10⁻¹⁰ | 1.20*10⁻⁰⁹ | 1.00*10⁻⁰⁹ |
| D₁₂ | 0.0000104 | 0.00000137 | 0.00000514 | 0.00000206 | 0.00000136 |
| ρ_{liq} (in kg · m⁻³) | 789 | 999 | 1100 | 1261.3 | 1125.5 |
| pᵥₐₚ (in Pa) | 6000 | 19 | 11 | 0.01 | 0.02 |
| τ (in s) | 0.1 | 75 | 83 | 175063 | 72638 |

The values of the characteristic time for evaporation of the solvents above were measured on an experimental device as described in examples 1 to 10. The experimental values are indeed in agreement with the theoretical values obtained according to equation Math4. In particular, with a pipette diameter of 1.5*10⁻⁵ m, TEG alone or the glycerol alone constitute solvents which are not sufficiently volatile in order to allow the solidification of the ink once it is deposited.

### Example 1: Silver Nanoparticles-Commercial Ink

A commercial ink PVnanocell ref (Sycris™ I40DM-106), for which the composition indicated by the supplier comprises:
silver nanoparticles (d50=70 nm, d90=152 nm, determined by Lumisizer®) coated with a layer of polyvinylpyrrolidone; their concentration by mass is between 38% and 42% by weight, i.e. approximately 5.8 vol %.
solvent DGME,
is injected in a drawn glass capillary (=pipette) the diameter of which at the tip is as indicated in table 1, taking care that the liquid does indeed reach the end of the tip of the pipette.

The pipette is fixed on one of the two tines of the diapason and its tip is approached according to the method described in FIG. 2 of application WO 2020/128310. In a first step, the tip of the pipette is approached mechanically using micrometric verniers, to a distance less than 300 μm from the substrate, in this case a silicon wafer. Then, the approach to the contact with the substrate is carried out using the loop which maintains the resonance of the diapason (phase-locked loop (PLL)) and the feedback control loop on the piezoscanner in order to attain the contact between the tip of the pipette and the substrate. Here the substrate is placed on the piezoscanner, the pipette is therefore fixed and it is the substrate which approaches it.

The contact is maintained by applying a constraint on the frequency shift (FS) of the resonance, said shift resulting from the interaction between the pipette and the substrate. The value of frequency shift, FS, used is 150 mHz (milliHerz).

The amplitude of oscillation of the diapason (and therefore of the pipette) is fixed at 10 nm. When the contact is made, a meniscus of the liquid contained in the pipette (the ink) appears between the tip of the pipette and the substrate.

Once the contact is established, the substrate is withdrawn from the pipette in accordance with one of the two following modes:
1) the feedback control loop of the piezoscanner is kept active:
The appearance of the solid phase induces local unevenness on the substrate, which leads to an FS detected by the PLL. The piezoscanner responds to this increase in FS by sufficiently withdrawing from the substrate to return to the setpoint value of the FS fixed at 150 mHz. Thus the creation of the pillar is initiated. This routine continues autonomously as long as the operator leaves the feedback control loop active and the pillar is continuously drawn from the tip of the pipette. The deactivation of the feedback control loop of the piezoscanner suspends the generation of the pillar.

In order to detach the pipette from the pillar, it is withdrawn at a speed of at least 10 μm/s.
2) the feedback control loop of the piezoscanner is deactivated:
just after the formation of the meniscus, the operator waits 1 s to 60 s in contact in order to initiate the formation of the pillar, before manually withdrawing the substrate from the pipette using the control software. The distance increments have a value from 0.01 to 10 μm, giving withdraw speeds ranging from 0.01 to 10 μm/s.

In order to detach the pipette from the pillar once the correct size is obtained, the method proceeds as in the preceding point.

All the steps of the method are carried out at ambient temperature (18-22° C.) and at atmospheric pressure.

The results obtained are summarised in the following table:

TABLE 1

| | | | Servo | | | Height | Base |
|---|---|---|---|---|---|---|---|
| Test | D | Ve | controlled | Vr | Shape | (μm) | diameter |
| 1 | 1 | 0.1 | Yes | 10 | Smooth column of | 10 | 1 |
| | | | | | substantially | | |
| | | | | | constant diameter, | | |
| | | | | | terminating in a | | |
| | | | | | flat top | | |
| 2 | 1 | 0.1 | No, | 10 | Stratified column of | 8 | 1 |
| | | | increments | | substantially | | |
| | | | of 100 nm | | constant diameter, | | |
| | | | | | terminating in a | | |
| | | | | | conical top | | |
| 3 | 7 | 2 | Yes | 100 | Smooth column of | 55 | 10 |
| | | | | | substantially | | |
| | | | | | constant diameter | | |
| | | | | | of approximately 7 | | |
| | | | | | μm, terminating in | | |
| | | | | | a flat top | | |
| 4 | 7 | 1 | No, with | 100 | Stratified column of | 40 | 10 |
| | | | increments | | substantially | | |
| | | | of 1 μm | | constant diameter | | |
| | | | | | of approximately 8 | | |
| | | | | | μm, terminating in | | |
| | | | | | a flat top | | |
| 5 | 7 | 1 | No, with | 10 | Stratified column of | 50 | 10 |
| | | | increments | | substantially | | |
| | | | of 1 μm | | constant diameter | | |
| | | | | | of approximately 8 | | |
| | | | | | μm, terminating in | | |
| | | | | | a conical shaped | | |
| | | | | | top | | |
| 6 | 7 | 3.2 | No, with | 100 | Smooth column with | 105 | 10 |
| | | | increments | | a diameters varying | | |
| | | | of 100 nm | | from 6 to 10 μm, | | |
| | | | | | giving an undulating | | |
| | | | | | shape | | |
| 7 | 7 | 5 | No, with | 10 | Rounded conical pin | 22 | 10 |
| | | | increments | | having a diameter | | |
| | | | of 100 nm | | which decreases in | | |
| | | | | | the direction of the | | |
| | | | | | height. | | |
| | | | | | Vertical slope of | | |
| | | | | | 30°. | | |
| 8 | 7 | 20 | No | 20 | No column or pin. | 3 | 10 |
| | | | | | Flattened dome | | |
| 9 | 10 | 10 | No, with | 10 | Rounded conical pin | 22 | 14 |
| | | | increments | | having a diameter | | |
| | | | of 100 nm | | which decreases in | | |
| | | | | | the direction of the | | |
| | | | | | height. | | |
| | | | | | Vertical slope of | | |
| | | | | | 20°. | | |
| 10 | 10 | 1 | No, with | 10 | Stratified column of | 55 | 15 |
| | | | increments | | substantially | | |
| | | | of 1 μm | | constant diameter | | |
| | | | | | of approximately 11 | | |
| | | | | | μm, terminating in | | |
| | | | | | a rounded conical | | |
| | | | | | shaped top | | |
| 11 | 10 | 1 | No, with | 100 | Stratified column of | 50 | 15 |
| | | | increments | | substantially | | |
| | | | of 1 μm | | constant diameter | | |
| | | | | | of approximately 11 | | |
| | | | | | μm, terminating in | | |
| | | | | | a flat top | | |
| 12 | 30 | 0.01 | Yes | 10 | Rounded conical pin | 50 | 150 |
| | | | | | having a diameter | | |
| | | | | | which decreases in | | |
| | | | | | the direction of the | | |
| | | | | | height. | | |
| | | | | | Vertical slope of | | |
| | | | | | 15°. | | |
| 13 | 30 | 10 | No | 10 | No column nor pin. | 3 | 100 |
| | | | | | Flattened dome | | |

D = Pipette diameter (μm)
Ve = Withdraw speed (μm/s)
Vr = Breakage speed (μm/s)
The following figures are given:
FIG. 4A: A pillar obtained according to test 3;
FIG. 4B: A pillar obtained according to test 4;
FIG. 4C: the flattened dome according to test 8

With a pipette of diameter 30 μm, the ratio of area of deposition over volume of ink to be deposited is higher. In order to allow a more rapid solidification of the nanoparticles and thus obtain a pillar having a constant diameter over its height, a more volatile solvent is required than DGME.

During test 8, the withdraw speed is too fast to form a pillar.

During test 9, a pillar is able to be drawn but does not form a column of substantially constant diameter.

The pillars are then cured at 150° C. for 30 minutes on a hot plate.

### Example 2: Silver Nanoparticles-Diluted Commercial Ink

The ink of example 1 is diluted with a similar solvent, DGEE, in order to obtain a volume concentration of nanoparticles of 5 vol % (=35% by weight).

The approach and contact are carried out as described in example 1, with a pipette for which the tip diameter is 1.5 μm or 8 μm. The feedback control loop is not activated. The results obtained are summarised in the following table:

TABLE 2

| | | | | | | | | Base |
|---|---|---|---|---|---|---|---|---|
| | | | | | | | Height | diameter |
| Test | D | Ve | Increments | | Vr | Shape | (μm) | (μm) |
| 14 | 1.5 | 3 | 100 | nm | 10 | Stratified column of | 5.5 | 1.5 |
| | | | | | | substantially constant | | |
| | | | | | | diameter, terminating in | | |
| | | | | | | a rounded conical | | |
| | | | | | | shaped top | | |
| 15 | 8 | 1 | 1 | μm | 100 | Stratified column of | 30 | 10 |
| | | | | | | substantially constant | | |
| | | | | | | diameter, terminating in | | |
| | | | | | | a flat top | | |
| 16 | 8 | 1 | 10 | nm | 100 | Smooth column of | 22 | 9 |
| | | | | | | substantially constant | | |
| | | | | | | diameter, terminating in | | |
| | | | | | | a flat top | | |
| 17 | 8 | 10 | 100 | nm | 10 | No column | 10 | 10 |
| | | | | | | Rounded conical pin | | |
| | | | | | | having a diameter which | | |
| | | | | | | decreases in the | | |
| | | | | | | direction of the height. | | |
| | | | | | | Vertical slope of 18°. | | |
| 18 | 8 | 20 | 100 | nm | 20 | No column or even a pin | 1 | 9 |

Flattened lens

D = Pipette diameter (μm)
Ve = Withdraw speed (μm/s)
Vr = Breakage speed (μm/s)

The ink being more diluted, and the quantity of liquid to evaporate in order to obtain the solid phase of the nanoparticles being larger, the withdraw speed is slower. The pillars are then cured at 150° C. for 30 minutes on a hot plate.

### Example 3: Silver Nanoparticles-Concentrated Commercial Ink

The ink of example 1 is centrifuged for 30 minutes at 7000 rpm in order to remove the solvent DGME and increase the concentration of nanoparticles.

Glycerol is added as second solvent in order to attain the following formulation:
nanoparticles: 10 vol %;
DGME: 65 vol %;
glycerol: 25 vol %.

The approach and contact are carried out as described in example 1, with a pipette for which the tip diameter is 1.5 μm or 8 μm. The feedback control loop is deactivated.

The results obtained are summarised in the following table:

TABLE 3

| | | | | | | Base |
|---|---|---|---|---|---|---|
| | | | | | Height | diameter |
| Test | D | Ve | Vr | Shape | (μm) | (μm) |
| 19 | 1.5 | 0.4 | 10 | Stratified column of | 12 | 1.5 |
| | | | | substantially constant | | |
| | | | | diameter, terminating in a | | |
| | | | | rounded conical shaped top | | |
| 20 | 8 | 0.1 | 100 | Smooth column of | 35 | 11 |
| | | | | substantially constant | | |
| | | | | diameter, terminating in a | | |
| | | | | flat top | | |
| 21 | 8 | 0.1 | 10 | Smooth column of | 11 | 12 |
| | | | | substantially constant | | |
| | | | | diameter, terminating in a | | |
| | | | | rounded conical shaped top | | |

D = Pipette diameter (μm)
Ve = Withdraw speed (μm/s)
Vr = Breakage speed (μm/s)

The ink is deposited and drawn in order to form columns without the pipette plugging. The low volatility of the glycerol compensates for the increased volume fraction of nanoparticles. The pillars are then cured at 150° C. for 30 minutes on a hot plate.

### Example 4: Silver Nanoparticles-Commercial Ink

The ink used is the commercial ink PVnanocell ref (Sycris™ P75DB-1), for which the composition indicated by the supplier comprises:
silver nanoparticles (d50=70 nm, d90=130 nm, determined by Lumisizer®) coated with a layer of polyvinylpyrrolidone; their concentration by mass is between 72 and 78% by weight, i.e. approximately 10 vol %.
the solvent DGBE.

The approach and contact are carried out as described in example 1, with a pipette, for which the tip diameter is given in the following table. The feedback control loop is deactivated.

The results obtained are summarised in the following table:

TABLE 4

| | | | | | | Base |
|---|---|---|---|---|---|---|
| | | | | | Height | diameter |
| Test | D | Ve | Vr | Shape | (μm) | (μm) |
| 22 | 1.5 | 1 | 10 | Stratified column of | 4.5 | 2 |
| | | | | substantially constant | | |
| | | | | diameter, terminating in | | |
| | | | | a rounded conical shaped | | |
| | | | | top | | |
| 23 | 5 | 0.3 | 10 | Smooth column of | 36 | 7 |
| | | | | substantially constant | | |
| | | | | diameter, terminating in | | |
| | | | | a rounded conical shaped | | |
| | | | | top | | |
| 24 | 5 | 0.2 | 100 | Smooth column of | 42 | 8 |
| | | | | substantially constant | | |
| | | | | diameter, terminating in | | |
| | | | | a flat top | | |
| 25 | 8 | 0.01 | 10 | Rounded conical pin | 10 | 11 |
| | | | | having a diameter which | | |
| | | | | decreases in the direction | | |
| | | | | of the height. | | |
| | | | | Vertical slope of 22°. | | |

D = Pipette diameter (μm)
Ve = Withdraw speed (μm/s)
Vr = Breakage speed (μm/s)

The solvent DGBE is less volatile than DGME; under the same conditions of temperature and atmospheric pressure it evaporates less quickly than DGME, for which reason the withdrawing speed is lower.

The pillars are then cured at 150° C. for 30 minutes on a hot plate.

### Comparative Test 1:

The ink of example 1 is centrifuged for 30 minutes at 7000 rpm in order to remove the solvent DGME and increase the concentration of nanoparticles.
nanoparticles: 16 vol %;
DGME: 84 vol %;

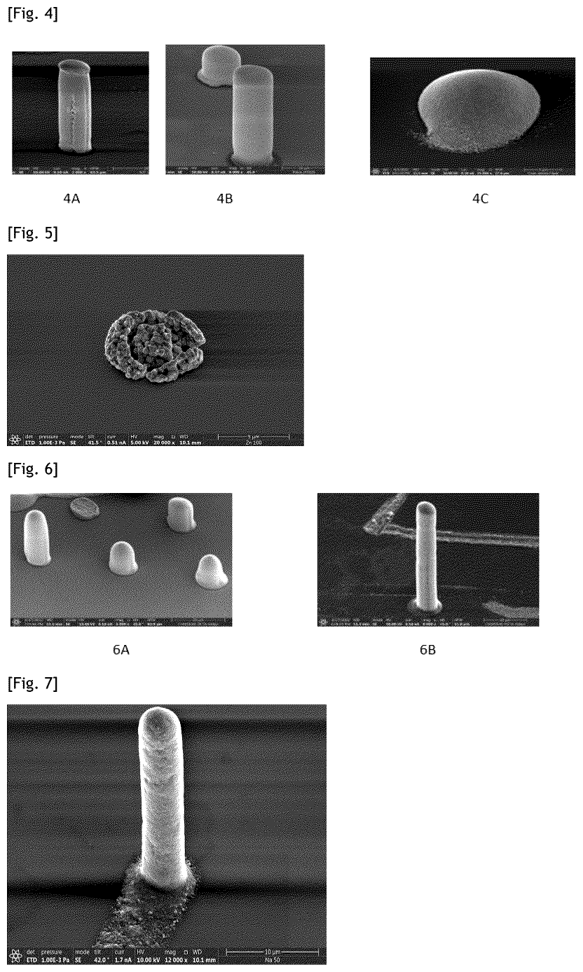

The approach and contact are carried out as described in example 1, with a pipette, for which the tip diameter is 8 μm. The pipette plugs too rapidly to be able to form pillars. No matter how fast the pipette withdraws, only a few particles are deposited on the substrate (see FIG. 5).

### Example 5: Copper Nanoparticles-Diluted Commercial Ink

The commercial ink PVnanocell ref (Sycris™ IC50DM-7), for which the composition indicated by the supplier comprises:
copper nanoparticles (d50=50 nm, d90=120 nm, determined by Lumisizer®) coated with a layer of polyvinylpyrrolidone; their concentration by mass is between 48% and 52% by weight, i.e. approximately 9.8 vol %.
the solvent DGME,
is diluted with DGME or DGEE and glycerol, with volume proportions 70:15:15-ink:DGEE/DGME:glycerol. The volume fraction thus attained is 6.5 vol % of copper nanoparticles.

The approach and contact are carried out as described in example 1, with a pipette, for which the tip diameter is 5 or 10 μm. The feedback control loop is deactivated.

The pillars are then cured at 150° C. for 30 minutes on a hot plate under a nitrogen atmosphere.

The results obtained are summarised in the following table:

TABLE 5

| | | | | | Height | Base |
|---|---|---|---|---|---|---|
| Test | D | Ve | Vr | Shape | (μm) | diameter (μm) |
| 26 | 5 | 10 | 10 | Rounded conical pin having a | 7 | 5 |
| | | | | diameter which decreases in | | |
| | | | | the direction of the height | | |
| | | | | Vertical slope of 16°. | | |
| 27 | 5 | 1 | 10 | Smooth column of | 48 | 7 |
| | | | | substantially constant | | |
| | | | | diameter, terminating in a | | |
| | | | | rounded conical shaped top | | |
| 28 | 5 | 1 | 100 | Smooth column of | 42 | 7 |
| | | | | substantially constant | | |
| | | | | diameter, terminating in a | | |
| | | | | flat top | | |
| 29 | 10 | 10 | 10 | Rounded conical pin having a | 10 | 12 |
| | | | | diameter which decreases in | | |
| | | | | the direction of the height. | | |
| | | | | Vertical slope of 26°. | | |
| 30 | 10 | 100 | 100 | No column, nor even a pin | 3 | 11 |
| | | | | Flattened dome | | |
| 31 | 10 | 1 | 100 | Smooth column of | 40 | 13 |
| | | | | substantially constant | | |
| | | | | diameter, terminating in a | | |
| | | | | flat top | | |

D = Pipette diameter (μm)
Ve = Withdraw speed (μm/s)
Vr = Breakage speed (μm/s)

Examples of photographs are given in FIG. 6. FIG. 6A: D=5 μm, FIG. 6B: D=10 μm.

### Example 6: Copper Nanoparticles-Diluted Commercial Ink

The commercial ink PVnanocell ref (Sycris™ IC50DM-7), for which the composition indicated by the supplier comprises:
copper nanoparticles (d50=50 nm, d90=120 nm, determined by Multisizer®) coated with a layer of polyvinylpyrrolidone; their concentration by mass is between 48% and 52% by weight, i.e. approximately 9.8 vol %.
the solvent DGME,
is diluted with DGME or DGEE and glycerol, with volume proportions 50:40:10-ink:DGEE/DGME:glycerol. The volume fraction thus attained is 4.9 vol % of copper nanoparticles.

The approach and contact are carried out as described in example 1, with a pipette, for which the tip diameter is 5 μm. The feedback control loop is deactivated.

The pillars are then cured at 150° C. for 30 minutes on a hot plate under a nitrogen atmosphere.

The results obtained are summarised in the following table:

TABLE 6

| | | | | | | Height | Base |
|---|---|---|---|---|---|---|---|
| Test | Ve | Increments | | Vr | Shape | (μm) | diameter (μm) |
| 32 | 0.15 | 10 | nm | 20 | Smooth column of | 22 μm | 7 |
| | | | | | substantially constant | | |
| | | | | | diameter, terminating | | |
| | | | | | in a rounded top | | |
| 33 | 1 | 1 | μm | 100 | Stratified column of | 20 μm | 6 |

substantially constant
diameter, terminating
in a flat top

Ve = Withdraw speed (μm/s)
Vr = Breakage speed (μm/s)

FIG. 7 shows the photograph corresponding to test 32.

### Comparative Example 2

The commercial ink PVnanocell ref (Sycris IC50DM-7) for which the composition indicated by the supplier comprises:
copper nanoparticles (d50=50 nm, d90=120 nm, determined by Multisizer®) coated with a layer of polyvinylpyrrolidone; their concentration by mass is between 48% and 52% by weight, i.e. approximately 9.8 vol %.
the solvent DGME,
is diluted with glycerol to 50-50 by volume proportions.

The volume fraction thus attained is 4.9 vol % of copper nanoparticles.

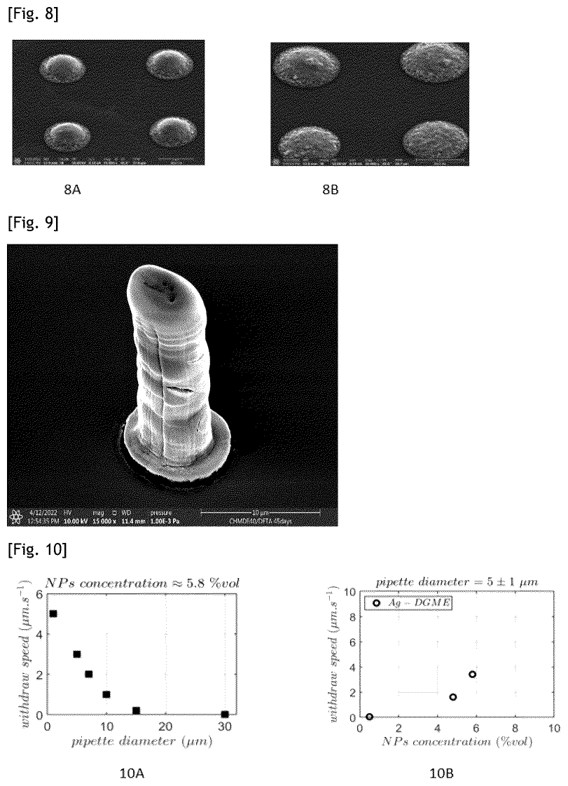

Following the same routine as previously to form pillars, lines and dots of ink were deposited (see FIGS. 8A, 8B) containing nanoparticles, using a 5 μm pipette, but it was not possible to create pillars, even at withdraw speeds as low as 0.01 μm/s.

Here the solvent is not volatile enough; even after complete evaporation of the DGME sufficient glycerol remains to keep the ink liquid and prevent the solidification of the nanoparticles.

### Example 7: Gold Nanoparticles-Commercial Ink

A gold ink manufactured in the laboratory and composed of:
gold nanoparticles (d50=6 nm and d90=10 nm, determined by dynamic light scattering-DLS) coated with a layer of dispersant; their volume concentration is 0.4 vol %.
ethanol as component 1 of the first solvent, at a level of 59.6 vol %,
water as component 2 of the first solvent, at a level of 30 vol %,
glycerol as second solvent, at a level of 10 vol %,
is injected in a pipette of diameter 1.5 or 8 μm, following the protocol detailed in example 1. The feedback control loop is deactivated. The speed of breakage is 100 μm/s.

The pillars are then cured at 200° C. for 30 minutes on a hot plate.

The results obtained are summarised in the following table:

TABLE 7

| | | | | | Base |
|---|---|---|---|---|---|
| | | | | Height | diameter |
| Test | D | Ve | Shape | (μm) | (μm) |
| 34 | 1.5 | 0.15 | Stratified column of | 8 | 5 |
| | | | substantially constant | | |
| | | | diameter, terminating in a | | |
| | | | conical top | | |
| 35 | 8 | 0.05 | Stratified column of | 17 | 9 |
| | | | substantially constant | | |
| | | | diameter, terminating in a flat | | |
| | | | top | | |

D = Pipette diameter (μm)
Ve = Withdraw speed (μm/s)

FIG. 9 shows the photograph corresponding to test 35.

### Example 8: Variation in the Withdraw Speed as a Function of the Diameter of the Pipette

The ink of example 1 is used in order to form pillars, by following the protocol detailed in example 1. The maximum speed of formation of a pillar without rupturing the meniscus is reported in the graph of FIG. 10A as a function of the diameter of the pipette used, and in the graph of FIG. 10B as a function of the volume fraction of nanoparticles. The diameter of the pipette varies from 1 to 30 μm. It is observed that the more the diameter of the pipette is increased, the more the withdraw speed must be decreased in order to form pillars. The surface/volume ratio increases and the time necessary for evaporating the solvent increases with the size of the meniscus, thus the diameter of the pipette.

The volume fraction varies between 0 and 6 vol %. The higher the volume fraction occupied by the nanoparticles, the faster the withdraw speed in order to form a pillar. The quantity of solvent to be evaporated being less when the volume fraction of nanoparticles increases; the solidification of the ink in the meniscus is attained more rapidly.

### Example 9: Conductive Line Connected to a Pillar, Made of Silver or Copper

The inks of examples 4 (for silver) and 6 (for copper) are used here to deposit a conductive line and then a pillar; tests 36 and 37 respectively.

The approach and contact are carried out as described in example 1, with a pipette, for which the tip diameter is 5 μm. Once the pipette is in contact, the PLL loop is kept active in order to keep the pipette close to the surface and therefore avoid rupturing the meniscus. The substrate is moved horizontally at a speed ranging from 1 to 1000 μm/s so as to deposit the ink along the path drawn by the pipette on the substrate. Once the line of nanoparticles is formed, the pipette is kept in contact and immobile for 1 s to 30 s, then the substrate is withdrawn from the pipette as described in example 1 (the feedback control loop is deactivated). A pillar is thus obtained.

The pillars are then cured at 150° C. for 30 minutes (under a nitrogen atmosphere for copper) on a hot plate.

The results obtained are summarised in the following table:

TABLE 8

| | | | | | Height | Base |
|---|---|---|---|---|---|---|
| Test | Ve | Increments | Vr | Shape | (μm) | diameter (μm) |
| 36 | 0.2 | 10 nm | 100 | Conductive line of | 26 | 9 |
| | | | | silver connected to a | | |
| | | | | smooth column of | | |
| | | | | substantially constant | | |
| | | | | diameter, terminating | | |
| | | | | in a flat top | | |
| 37 | 1 | 100 nm | 100 | Conductive line of | 20 | 7 |
| | | | | copper connected to a | | |
| | | | | smooth column of | | |
| | | | | substantially constant | | |
| | | | | diameter, terminating | | |
| | | | | in a flat top | | |

Ve = Withdraw speed (μm/s)
Vr = Breakage speed (μm/s)

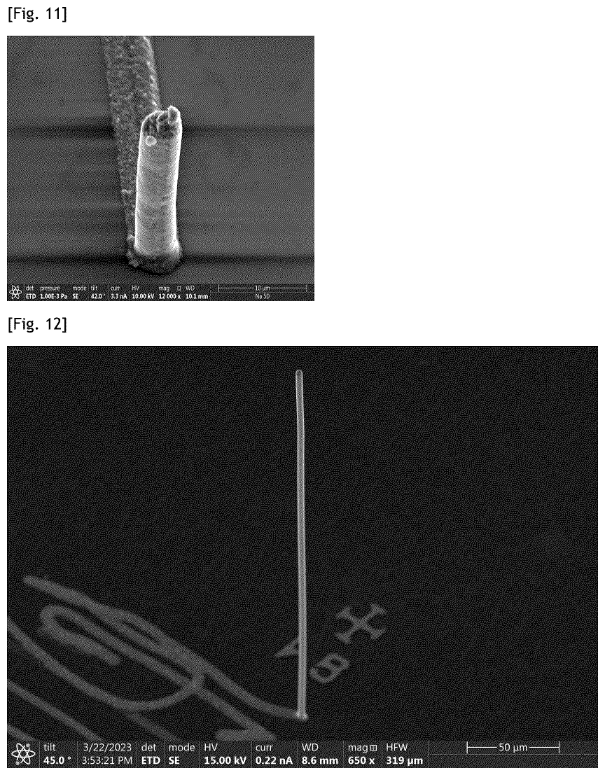

FIG. 11 shows the photograph corresponding to test 37.

### Example 10: Silver Nanoparticles-Commercial Ink

The ink of example 1 is used in this example.

It is injected in a pipette of diameter 4 μm, following the protocol detailed in example 1. The feedback control loop is activated. The speed of breakage is 100 μm/s. The pillars are then cured at 200° C. for 30 minutes on a hot plate.

A pillar of diameter 4 μm and height 280 μm is obtained (aspect ratio 70). An SEM image of this pillar is shown in FIG. 12.

1. A method for manufacturing a three-dimensional nanostructure, the method comprising the following steps:
oscillating an injector (100) between a low position in contact with a substrate (20) and a high position out of contact with the substrate (20), the injector (100) comprising an ejection orifice (108) the diameter of which is greater than 0.1 μm;
depositing an ink on the substrate (20) by means of the injector during a contact of the ejection orifice (108) of the injector (100) with the substrate (20), the ink comprising, in % by volume relative to the total volume of the ink:
less than 15% nanoparticles chosen from metal nanoparticles, metal oxide nanoparticles, graphene oxide nanoparticles, quantum dots, or combinations thereof;
0.5% to 5% dispersant,
at least 80% of a solvent capable of dispersing the metal nanoparticles to form the ink to be injected and sufficiently volatile to allow solidification of the ink once it is deposited; and
withdrawing the injector (100) away from the substrate (20) at a speed of less than or equal to 10 μm/s in a direction substantially perpendicular to the substrate while maintaining a flow of ink exiting from the injector.

2. The method of claim 1, wherein the ink comprises from 0.05% to 15% by volume, of nanoparticles, relative to the total volume of the ink.

3. The method according of claim 1, wherein the diameter of the ejection orifice (108) ranges from 0.1 μm to 50 μm.

4. The method of claim 1, wherein the volatile solvent comprises a solvent selected from the group consisting of water, an alcohol, a glycol, a glycol ether and mixtures thereof.

5. The method of claim 4, wherein the ink comprises 80% to 99.45% by volume of the volatile solvent, relative to the total volume of the ink.

6. The method of claim 4, wherein the volatile solvent further comprises glycerol.

7. The method of claim 1, wherein the metal of the metal nanoparticles is selected from the group consisting of silver, copper, gold, platinum, nickel, aluminium, cobalt, zinc, indium, palladium, and combinations or alloys thereof.

8. The method of claim 1, wherein the metal oxide of the metal oxide nanoparticles is ZnO, TiO₂, ITO (indium-tin oxide) or V₂O₅.

9. The method of claim 1, wherein the ink further comprises a dispersant.

10. The method of claim 1, wherein the injector withdraws at a speed ranging from 1 μm/s to 10 μm/s during the step of withdrawing the injector away from the substrate.

11. The method of claim 1, further comprising a step of breakage between the three-dimensional nanostructure formed and the ink to be deposited, advantageously by withdrawing the injector (100) away from the substrate (20) at a speed greater than 10 μm/s.

12. The method of claim 1, further comprising carrying out, at least once, a cycle of the following steps so as to form at least one second three-dimensional nanostructure:
moving the injector in relation to the substrate (20) in a direction parallel (x,y) to the substrate, and
carrying out the steps of claim 1.

13. The method of claim 1, further comprising a step of curing the substrate containing the nanostructure formed.

14. A product comprising a substrate on which is deposited at least one three-dimensional nanostructure obtained by means of a method according to claim 1, wherein the nanostructure is in the form of a conical pin having a diameter which decreases in upward direction and having at least one of the following features:
the diameter of the base varies from 0.5 μm to 50 μm;
the diameter of the apex varies from 0.2 μm to 30 μm;
the angle of the slope with the vertical varies from 0.1° to 70°.

15. A product comprising a substrate on which is deposited at least one three-dimensional nanostructure obtained by means of a method according to claim 1, wherein the nanostructure is in the form of a column having a height at least fifteen times greater than the diameter of the base, the diameter of the base being advantageously less than 1 μm.

16. The method of claim 2, wherein the ink comprises from 0.2% to 10% by volume, of nanoparticles, relative to the total volume of the ink.

17. The method of claim 2, wherein the ink comprises from 4% to 8% by volume, of nanoparticles, relative to the total volume of the ink.

18. The method according of claim 3, wherein the diameter of the ejection orifice (108) ranges from 0.5 μm to 30 μm.

19. The method of claim 6, wherein the ink comprises from 0% to 25% by volume of glycerol, relative to the total volume of the ink.

20. The method of claim 9, wherein the dispersant is selected from the group consisting of polyvinylpyrrolidone (PVP), gum Arabic, polyvinyl alcohol (PVA), polyacrylic acid (PAA) polyallylamine (PAAm), polysodium styrene sulfonate (PSS), 3-(aminopropyl)trimethylsylane (APS), a fatty acid, cetyltrimethylammonium bromide (CTAB), tetraoctylammonium bromide (TOAB), sodium citrate, lauryl amine, dodecanethiol, mercapto-polyethylene glycol, mercapto-polypropylene glycol, and combinations thereof.
